(19) United States
(12) Patent Application Publication
(10) Pub. No.: US 2025/0351809 A1
(43) Pub. Date: Nov. 20, 2025

(54) SLOW SINKING FISHING WEIGHT

(71) Applicant: Kirk Blosch, Salt Lake City, UT (US)

(72) Inventor: Kirk Blosch, Salt Lake City, UT (US)

(21) Appl. No.: 19/204,493

(22) Filed: May 10, 2025

Related U.S. Application Data
(60) Provisional application No. 63/648,450, filed on May 16, 2024.

(51) Int. Cl. A01K 95/00

(52) U.S. Cl. CPC A01K 95/005

(57) ABSTRACT

A slow sinking fishing weight is made from a material having a bulk density which is slightly greater than the density of water and includes deep surface channels that significantly increase its resistance to movement in water. The fishing weight has a sink rate in calm water which is less than one foot per second. The slow sinking fishing weight allows a person to more easily maintain the depth of the sinking weight and an attached lure while moving the lure through the water.

### PRIORITY

The present application claims the benefit of U.S. Provisional Application Ser. No. 63/648,450, filed May 16, 2024, which is herein incorporated by reference in its entirety.

### THE FIELD OF THE INVENTION

The present invention relates to fishing. In particular, examples of the present invention relate to a fishing weight that sinks at a slow rate through water.

### INTRODUCTION

Fisherman often desire to use a weight in combination with a fishing lure or bait while fishing. A fishing weight is often attached to the leader or fishing line a few feet away from the fishing lure. Attaching a weight to the fishing line allows the fisherman to cast farther and makes the lure sink to the bottom of the water.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing which shows a slow sinking fishing weight in use.

FIG. 2 is a drawing which shows a side view of the slow sinking fishing weight.

FIG. 3 is a drawing which shows a top view of the slow sinking fishing weight.

FIG. 4 is a drawing which shows a perspective view of the slow sinking fishing weight.

FIG. 5 is a drawing which shows a front end view of the slow sinking fishing weight.

FIG. 6 is a drawing which shows a back end view of the slow sinking fishing weight.

FIG. 7 is a drawing which shows a top view of another embodiment of the slow sinking fishing weight.

FIG. 8 is a drawing which shows a top view of another embodiment of the slow sinking fishing weight.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be a significant digit above or a significant digit below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range.

The present application discloses a slow sinking fishing weight that sinks slowly in the water when the weight is undisturbed but which rises in the water without significant effort when the weight is pulled through the water. The slow sinking fishing weight may be used in combination with many different types of fishing lures and the properties of the slow sinking fishing weight to control the lure and allow the lure to sink through the water once it is cast into the water and to rise in the water when the fisherman reels the lure in or pulls the lure through the water such as when trolling behind a boat. The fisherman is then able to easily move the lure up and down through the water and control the depth of the lure in the water while reeling in the lure or moving the lure through the water to simulate a small fish or other creature swimming through the water in a way that attracts fish. This motion is not possible for many different types of fishing lures such as artificial flies, worms, and edible baits. Lures such as these do not sink well in the water and have insufficient casting weight to cast out far enough into a body of water. If a fisherman adds a casting weight such as a lead weight to the fishing line, sufficient weight for casting and causing the lure to sink is achieved, but the lure will no longer rise in the water when it is slowly reeled in or moved laterally through the water. Lures such as spinning lures sink well in the water but are difficult to get to rise in the water while being pulled through the water, making it difficult to control the height of the lure in the water. The lure may be drug across the bottom of the waterway in a way that often results in the hook becoming snagged on debris. The lure moves through the water in a way that is not realistic and does not readily attract fish.

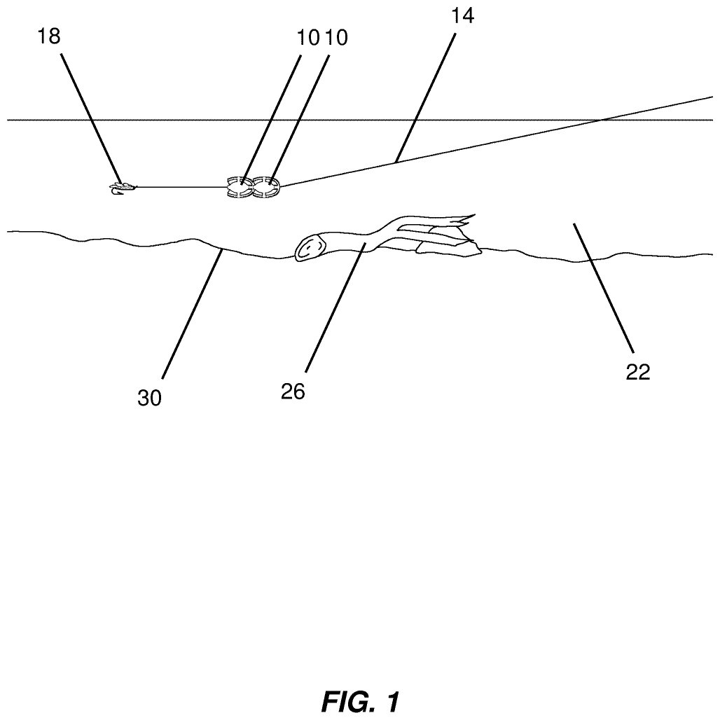

Turning now to FIG. 1, a drawing of a slow sinking fishing weight 10 in use while fishing is shown. The slow sinking fishing weight 10 is attached to a fishing line 14 along with a fishing lure 18. The fishing weight 10 may be used to add weight to a fishing line 14 to increase the casting distance and to cause the lure 18 to sink in the water 22. The example fishing weight 10 weighs about 15 grams. As shown, a few fishing weights 10 may be stacked together (i.e. placed sequentially) on the fishing line 14 to achieve a desired casting weight. The fishing weights 10 have rounded front ends and concave back ends and stack together in a chain with nesting front and back ends that help multiple fishing weights 10 nest together and work together well. The slow sinking fishing weight 10 sinks slowly through the water 22 and provides resistance to moving through the water 22 so that a small vertical force component applied to the fishing weight 10 by a fishing line 14 as the weight 10 is pulled through the water causes the fishing weight 10 to rise in the water 22, thereby causing the lure 18 to rise through the water 22. As a fisherman is nearly always above the surface of the water 22, the fishing line 14 extends upwardly from the slow sinking fishing weight 10 by an angle that is often between about 5 and about 10 degrees. Applying tension to the fishing line 14 to reel in the line 14 or move the fishing lure 18 applies both a horizontal and a vertical force component to the fishing weight 10 and the vertical force component causes the fishing weight 10 to rise in the water 22. The fisherman is able to move the slow sinking fishing weight 10 and the lure 18 through the water at a slow horizontal speed while keeping the fishing weight 10 and lure 18 within a desired height range in the water column; avoiding debris 26 on the bottom 30 of the waterway and better simulating the natural prey of the fish.

Conventional fishing weights sink so quickly through the water that they must be pulled through the water at a high speed to keep them off of the bottom 30 of the waterway and avoid debris 26. This results in the fishing lure moving through the water at an unrealistically high speed that does not attract fish well.

The slow sinking fishing weight 10 functions well due to a slow sinking rate that is created by a combination of a low density and a higher resistance to movement through the water. The higher resistance to movement through the water increases the tension on the fishing line 14 for a given movement speed and thus increases the vertical force component applied to the slow sinking fishing weight 10 to keep the slow sinking fishing weight 10 off of the bottom 30 of the waterway and to raise the slow sinking fishing weight 10 and lure 18 in the water. Too high of a density in the slow sinking fishing weight 10 causes the weight to sink too quickly and makes it difficult to maintain the weight 10 and lure 18 at a desired elevation in the water. Similarly, too low of resistance to movement through the water results in too high of a movement speed through the water to control the height of the weight 10 and lure 18 in the water.

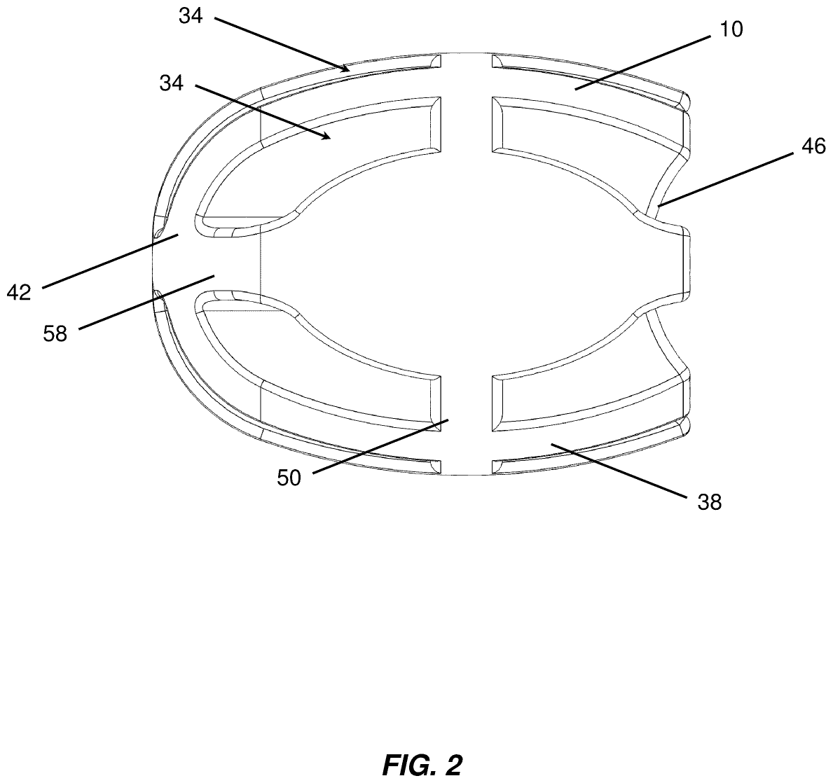

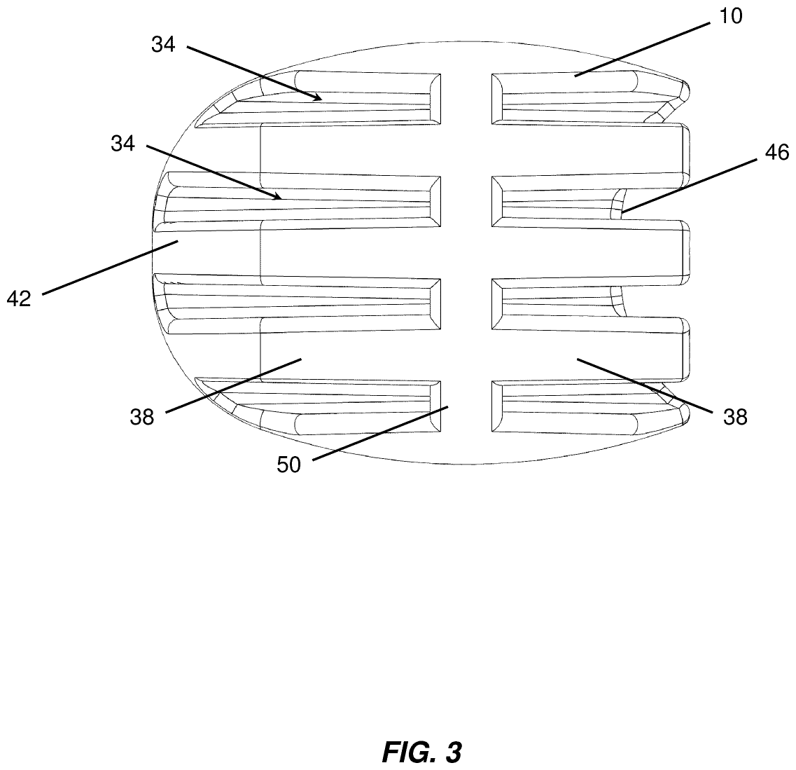

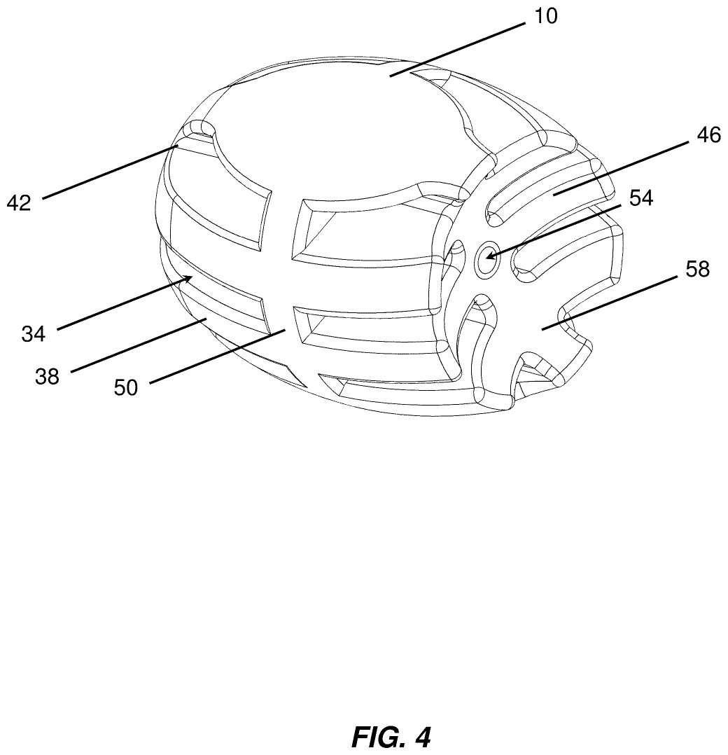

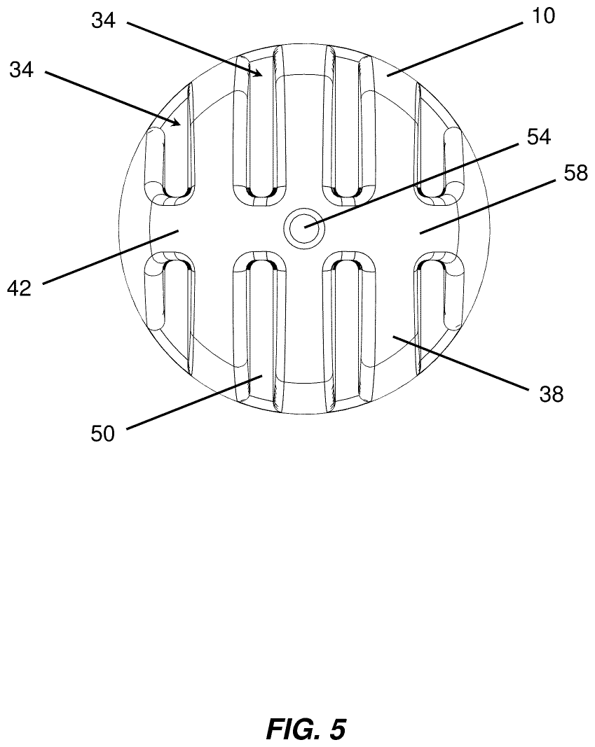

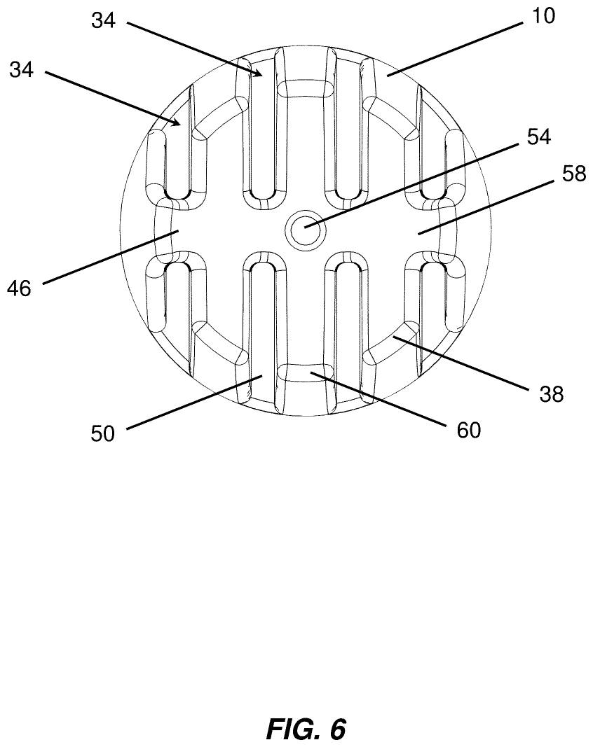

FIGS. 2 through 6 show drawings of the slow sinking fishing weight 10. FIG. 2 shows a side view of the fishing weight. FIG. 3 shows a top view of the fishing weight. FIG. 4 shows a perspective view of the back end of the fishing weight. FIG. 5 shows a front end view of the fishing weight. FIG. 6 shows a back end view of the fishing weight.

The slow sinking fishing weight 10 is made from a material such as a thermoplastic that has a density that is slightly greater than that of water. An example slow sinking fishing weight 10 may be made from ABS plastic. ABS plastic typically has a density which is greater than water, depending on its particular composition and the manufacturing process. An example slow sinking fishing weight made with a material that has a density that is between about 2 percent and about 8 percent greater than the density of the water will work. An example slow sinking fishing weight made with a material that has a density that is between about 2 percent and about 6 percent greater than the density of the water will work better. More particularly, a slow sinking fishing weight that has a density that is about 4 percent greater that water will work particularly well.

For fresh water (fresh water density is about 1.0 g/cc), an example slow sinking fishing weight 10 with a density which is between about 1.02 g/cc and about 1.08 g/cc works. A density between about 1.02 g/cc and about 1.06 g/cc works better. A density which is about 1.04 g/cc works even better. For salt water fishing in the ocean (salt water density is about 1.25 g/cc), an example slow sinking fishing weight 10 with a density which is between about 1.27 g/cc and about 1.35 g/cc works. A density between about 1.27 g/cc and about 1.33 g/cc works better. A density which is about 1.3 g/cc works even better. As described herein, the density of the slow sinking fishing weight 10 refers to the bulk density of the material that forms the slow sinking fishing weight 10. Bulk density refers to the density of the material including any air bubbles or added particles. In other words, the actual weight of 1 cc of the as molded material including any voids or porosity or added materials. The bulk density refers to the material used to manufacture the slow sinking fishing weight 10 and not to any surface features on the slow sinking fishing weight such as holes used to attach the weight to a fishing line or surface features to control the resistance to movement through the water.

A slow sinking fishing weight 10 may be manufactured at a desired bulk density by using a material that has a higher density than the desired bulk density and by adding entrained air bubbles or hollow spheres to the material in manufacturing material to create an end product with the desired bulk density. Alternatively, a slow sinking fishing weight 10 may be manufactured at a desired bulk density by using a material that has a lower density than the desired bulk density and by adding heavy particles such as metal or glass spheres to the material in manufacturing material to create an end product with the desired bulk density. Thus, a mixture of a low density plastic such as polypropylene and metal particles may be created with a bulk density of about 1.04 g/cc. Similarly, a mixture of a high density plastic such as acrylic and a light material such as hollow glass spheres or micro-balloons may be created with a bulk density of about 1.04 g/cc. Accordingly, multiple material requirements such as resistance to degradation in water and UV light as well as color, strength, and feel may be achieved while still achieving the desired bulk density of the manufactured slow sinking fishing weight 10.

A fishing weight that is simply made of a material with a bulk density that is slightly greater than that of water performs inadequately, however. Applicant has determined that conventional weight shapes such as oval or round weights that are made from a plastic with a density slightly greater than that of water will still sink through water almost as fast as a lead weight. These fast sinking conventional weights do not allow the fisherman to move the weight 10 and lure 18 slowly through the water in a horizontal direction while keeping the lure at a desired height within the water column. These conventional weights must be pulled quickly through the water just to keep the weight off of the bottom of the waterway. The slow sinking fishing weight 10 provides a significantly higher resistance to movement through the water so that a lower movement speed through the water results in enough tension in the fishing line 14 to provide a vertical force component high enough to offset the weight of the slow sinking fishing weight 10 and maintain the weight 10 at a desired height in the water column.

An example slow sinking fishing weight 10 is about 35 mm long and is about 30 mm in diameter (width and height). The example fishing weight 10 has an overall oval (ovoid) or elliptical shape and has a recessed rear end. Slow sinking fishing weights 10 may typically be between about 2 cm and about 6 cm long, more particularly between about 2 and about 4 cm long, and even more particularly about 3 or about 3.5 cm long. Slow sinking fishing weights 10 may typically be between about 2 cm and about 4 cm in diameter, and more particularly about 3 cm in diameter. The example slow sinking fishing weight 10 weighs about 15 grams. Slow sinking fishing weights 10 may be manufactured to weigh between about 10 and about 50 grams for many applications, more particularly between about 10 and about 20 grams, and in many cases about 15 grams.

The slow sinking fishing weight 10 is made with deep surface features that provide significant resistance to movement through the water. The deep surface features include recesses such as channels that extend into the surface of the fishing weight 10 and create projections such as ribs or posts between the channels. The distal ends of the ribs or posts define the outer shape of the fishing weight 10 and the channels extend inwardly from the outer shape. The example slow sinking fishing weight 10 includes deep surface channels 34 and projections such as ribs 38 formed between the channels 34. The channels are sufficiently wide for a significant amount of water to flow through the channels and the projecting ribs or posts are sufficiently wide to cause a disturbance to the water flow while the fishing weight 10 is pulled through the water. The example channels 34 are greater than 2 mm wide to allow a greater amount of water to flow between them. The channels are between about 2 mm wide and about 6 mm wide, preferably between about 2 mm wide and about 4 mm wide, and more preferably about 3 mm wide.

Similarly, the example projections 38 are greater than 2 mm wide to cause a greater obstruction to water flowing through the channels as the water is diverted around the projections 38. The projections are greater than 2 mm wide, preferably between about 2 mm wide and about 6 mm wide, preferably between about 2 mm wide and about 4 mm wide, and more preferably about 3 mm wide. The use of wide channels 34 and projections 38 results in a significant water flow through the channels 34 and obstruction to water flow as the water flows around the projections 38. As the slow sinking fishing weight 10 moves through the water, the water collides with the projections 38 and moves around the projections 38 and through the channels 34 creating resistance to movement through the water

The channels 34 and ribs 38 create resistance to movement as water flows through the channels 34; causing the weight 10 to sink much more slowly through the water and also causing significantly increased drag on the fishing line 14 as the fishing weight 10 is pulled through the water. The example grooves/channels 34 are oriented along the length of the fishing weight 10 between the front end 42 and the back end 46 of the weight 10. Accordingly, the ribs 38 are also oriented along the fishing weight 10 from the front end 42 to the back end 46 of the fishing weight 10. The fishing weight 10 also includes a central transverse wall 50 that extends across the fishing weight 10 and intersects the channels 34. The central transverse wall 50 is positioned between the front end 42 and the back end 46 of the fishing weight 10 near the longitudinal middle of the fishing weight 10 and extends across the fishing weight between the sides of the fishing weight 10. The central transverse wall 50 interrupts the channels 34 and causes water that is flowing through the channels 34 to change direction and flow around the transverse wall 50 as the water flows through the front channels 34, out of the front channels 34 and around the transverse wall 50, and down into and through the rear channels 34.

The fishing weight 10 has a central plate 58 that is generally flat and is about 4 mm thick. The central plate 58 is typically between about 3 and about 6 mm thick, and more preferably about 4 mm thick. The central plate 58 is oriented along the fishing weight 10 from the front end 42 to the back end 46 of the fishing weight 10 such that the central plate 58 extends along the length of the fishing weight 10. The central plate 58 extends along the central axis of the fishing weight 10 and extends outwardly to the sides of the fishing weight 10. In the example fishing weight 10, the channels 34 and ribs/projections 38 extend outwardly from the central plate 58. The channels 34 and projections 38 extend perpendicularly from the central plate 58 on both sides of the central plate 58. The channels 34 and projections 38 both have aspect ratios (defined as the ratio of their height/depth to their width) between about 2:1 and about 6:1. Preferably, the channels 34 and the projections defined thereby have an aspect ratio greater than 1:1. Preferably, the channels 34 extend at least 50 percent of a distance between the fishing weight body outer surface and a central plane of the fishing weight body. Channels 34 that are both deep (an aspect ratio greater than 1:1) and wide (greater than about 2 mm wide) results in a significant flow of water through the channels 34 and a high drag created by the channels 34. The high drag created by the channels 34 and projections 38 means that the vertical drag component imparted by the upwardly angled fishing line 14 is sufficient to lift the fishing weight in the water column at a relatively low speed; making the depth of the fishing weight 10 within the water easier to control and making it easier to move the fishing weight 10 through the water at a lower, more realistic speed that is appealing to fish.

The fishing weight 10 includes an axial hole 54 that extends through the middle of the fishing weight 10 along its length. The axial hole 54 passes through the middle of the central plate 58. The axial hole 54 is about 2 mm in diameter and is sufficiently large to pass fishing line through the hole 54 to secure the fishing weight 10 to the fishing line. The fishing line 14 may be secured to the fishing weight 10 by tying the fishing line 14 in a loop around the fishing weight 10 or by using a tapered plug to wedge in the axial hole 54 next to the fishing line 14 and secure the fishing line 14 in the axial hole.

FIGS. 2 and 3 show how the example fishing weight 10 is generally oval or elliptically shaped when viewed from the side or the top/bottom of the fishing weight 10 with a truncated back end 46. The back end 46 of the fishing weight 10 has a concave recessed shape. In use, concave back end 46 allows multiple fishing weights 10 to be placed end to end along a fishing line 14 to increase the total casting weight and allow longer casts. The concave back end 46 receives the convex front end 42 of an adjacent fishing weight 10 and allows the stacked fishing weights 10 to work together well. FIG. 2 shows the fishing weight 10 with the central plate 58 oriented left to right and extending out of the plane of the image. The transverse wall 50 is oriented top to bottom and extends out of the plane of the image. FIG. 2 illustrates how the transverse wall 50 interrupts flow through the channels 34 and increases the drag of the fishing weight 10 moving through the water. FIG. 3 shows a top or bottom view of the fishing weight 10 and illustrates how the transverse wall 50 extends laterally across the fishing weight 10 and interrupts the channels 34.

FIG. 4 shows a rear perspective view of the fishing weight 10. The rear end 46 of the fishing weight 10 is concave, with a rounded concave surface that extends forwards to create a concave surface which is between about 5 mm and about 10 mm deep. As mentioned, two or more slow sinking fishing weights 10 can be used together by attaching them sequentially on the fishing line 14. The rounded front ends 42 nest in the concave rear ends 46.

FIGS. 5 and 6 show front and rear views of the fishing weight 10 respectively, and show the fishing weight 10 solid central plate 58. The central plate 58 extends between the front end 42 and back end 46 and between the sides of the fishing weight 10. The central plate 58 provides a central core to the fishing weight 10. The channels 34 extend from the top and bottom of the fishing weight towards the central plate 58 such that the ribs 38 extend from the central plate 58 to the top and bottom of the fishing weight 10. The axial hole 54 extends through the center of the central plate 58. It can be seen how the transverse wall 50 blocks the channels 34; causing water to flow initially through the channels 34 and then change direction to flow around the transverse wall 50 and back through the rear channels 34. FIG. 6 shows how the rear end 46 of the fishing weight 10 includes a shoulder 60 that transitions between the convex sides and concave rear of the fishing weight.

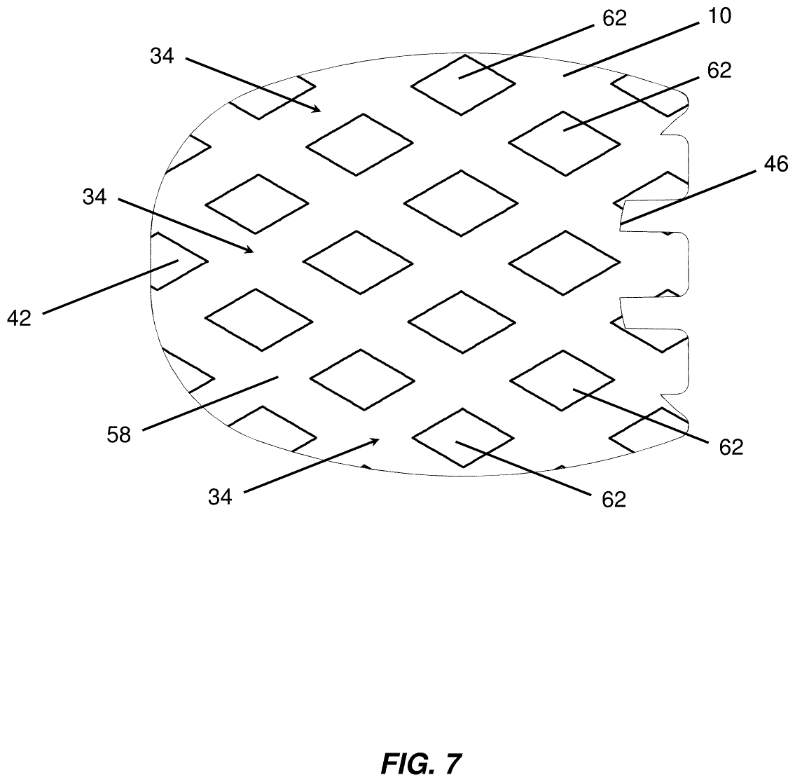

FIG. 7 shows a top view of another example fishing weight 10 where the channels 34 are oriented at angles relative to the longitudinal axis of the fishing weight 10. The channels 34 include a first group of channels 34 that are angled to the left side of the fishing weight 10 and a second group of channels 34 that are angled towards the right side of the fishing weight and intersect the first group of channels 34, creating posts/posts 62 that extend upwardly and downwardly from the central plate 58. The posts 62 have angled vertical edges. The posts 62 cause the water to repeatedly change course and flow around the posts 62 as it flows through the fishing weight, causing resistance as the fishing weight 10 is moved through the water. This embodiment of the fishing weight 10 is otherwise similar to the fishing weight described above.

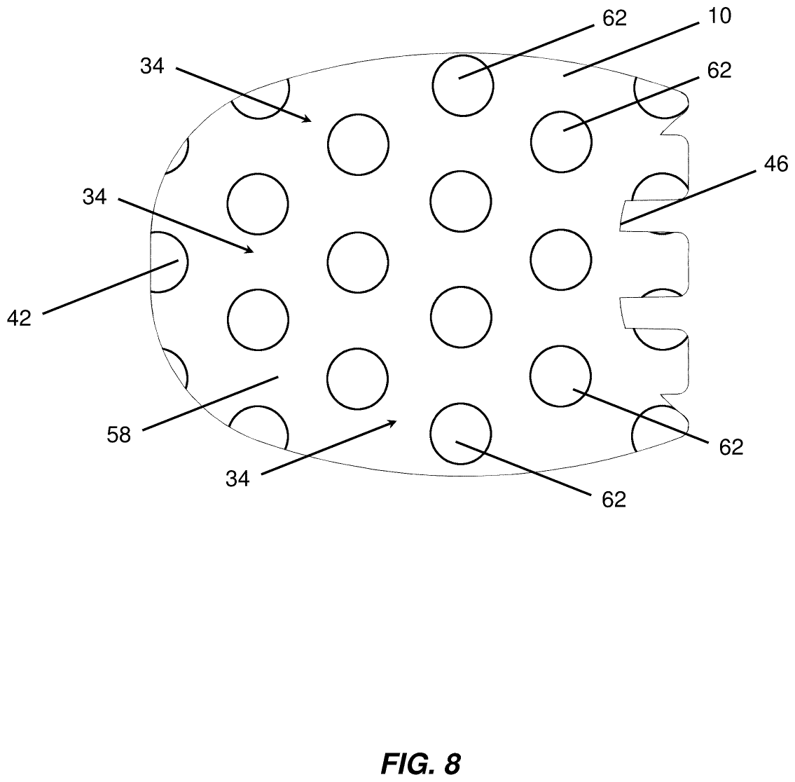

FIG. 8 shows a top view of another example fishing weight 10 where the channels 34 are oriented at angles relative to the longitudinal axis of the fishing weight 10. The channels 34 include a first group of channels 34 that are angled to the left side of the fishing weight 10 and a second group of channels 34 that are angled towards the right side of the fishing weight and intersect the first group of channels 34, creating rounded posts 62 that extend upwardly and downwardly from the central plate 58. The posts 62 cause the water to repeatedly change course and flow around the posts 62 as it flows through the fishing weight, causing resistance as the fishing weight 10 is moved through the water. This embodiment of the fishing weight 10 is otherwise similar to the fishing weight described above.

In testing, applicant found that plastic fishing weights with a smooth and rounded or elliptical external surface and a density of about 1.15 g/cc sank through calm water at about 90 to 120 cm per second; almost as fast as a lead fishing weight. In contrast, the example slow sinking fishing weights 10 with a density of less than about 1.1 g/cc and with deep surface features sinks through calm water at a rate which is typically less about 10 cm per second. Example slow sinking fishing weights 10 preferably have a sink rate in water which is less than about 30 cm per second, preferably between about 5 cm per second and about 20 cm per second, more preferably between about 5 cm per second and about 15 cm per second, and even more preferably about 10 cm per second.

The slow sinking fishing weight 10 allows the fisherman to more easily and precisely control the speed and depth of the fishing weight 10 and lure 18 in the water as the fishing weight 10 and lure 18 are moved through the water. The increased drag generated as the fishing weight 10 moves through the water allows the fisherman more control in the speed and depth of the fishing weight 10 as they move the slow sinking fishing weight 10 through the water. The drag and the slow sinking rate allow the fishing weight 10 to rise easier when the fisherman is pulling the fishing weight 10 through the water and allows the fisherman to control the depth of the fishing weight 10 and lure 18 in the water.

A fisherman may use multiple slow sinking fishing weights 10 together to achieve a desired casting weight. The example fishing weight 10 weighs about 15 grams. A fisherman may decide to use two or three fishing weights 10 to achieve a casting weight of 30 or 45 grams. Higher casting weight can be useful when fishing with thicker fishing line or when fishing at a larger distance from the fisherman. The stacked fishing weights 10 still provide elevated resistance to movement through the water that causes the fishing weights 10 to rise in the water when pulled through the water by the fisherman; allowing the fisherman to control the depth of the fishing weights 10 and lure 18 in the water.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A slow sinking fishing weight comprising:
a body having a rounded exterior comprising:
a central axis that extends from a front end to a back end of the body;
a central plate that extends between the front end and the back end of the body, wherein the central plate extends from the central axis towards left and right sides of the body;
a mounting hole configured to receive a fishing line therethrough, the mounting hole extending between the front end and the back end of the body along the central axis;
top channels that extend from the top of the body towards the central plate;
top projections located between the top channels;
bottom channels that extend from the bottom of the body towards the central plate;
bottom projections located between the bottom channels;
wherein the fishing weight body is made from a material having a bulk density which is between about 1.08 g/cc and about 1.02 g/cc; and
wherein the fishing weight has a sink rate in calm water which is less than about 30 cm per second.

2. The slow sinking fishing weight of claim 1, wherein the top channels extend longitudinally along the body and wherein the projections comprise ribs that extend between the top channels longitudinally along the body.

3. The slow sinking fishing weight of claim 2, further comprising a transverse wall that intersects the top channels.

4. The slow sinking fishing weight of claim 1, wherein the top channels have a width which is about 2 mm or greater, and wherein the top channels have a depth which is at least twice their width.

5. The slow sinking fishing weight of claim 1, wherein the top channels comprise a first group of channels that extend along the fishing weight body and a second group of channels that extend along the fishing weight body and intersect the first group of channels and wherein the top projections comprise posts located between the top channels.

6. The slow sinking fishing weight of claim 1, wherein the body is made from a material that has a bulk density which is between about 1.02 g/cc and about 1.06 g/cc.

7. The slow sinking fishing weight of claim 1, wherein the body is made from a material that has a bulk density which is about 1.04 g/cc.

8. The slow sinking fishing weight of claim 1, wherein the body has an ovoid outer shape and wherein a back end of the body has a concave shape, and wherein a first slow sinking weight may be attached to a fishing line adjacent a second slow sinking fishing weight such that the front end of the first slow sinking fishing weight is nested inside the concave back end of the second slow sinking fishing weight.

9. The slow sinking fishing weight of claim 1, wherein the slow sinking fishing weight has a sink rate in calm water which is between about 5 cm per second and about 20 cm per second.

10. The slow sinking fishing weight of claim 1, wherein the slow sinking fishing weight has a sink rate in calm water which is about 10 cm per second.

11. A slow sinking fishing weight comprising:
a body comprising:
a central axis that extends from a front end to a back end of the body;
a plurality of channels that each extend inwardly from an exterior of the body;
a plurality of projections located between the plurality of channels;
a mount which receives a fishing line to thereby attach the slow sinking fishing weight to the fishing line;
wherein the fishing weight body is made from a material having a bulk density which is between about 2 percent and about 8 percent greater than the density of a water selected from the group consisting of fresh water and ocean water; and
wherein the plurality of channels and plurality of projections comprise deep surface features that create sufficient resistance to movement through the water that the fishing weight has a sink rate in the water which is less than about 30 cm per second.

12. The slow sinking fishing weight of claim 11, wherein the plurality of channels extend longitudinally along the body and wherein the plurality of projections comprise ribs.

13. The slow sinking fishing weight of claim 12, further comprising a transverse wall that intersects the plurality of channels and interrupts water flow through the plurality of channels.

14. The slow sinking fishing weight of claim 11, wherein the plurality of channels have a width which is about 2 mm or greater, and wherein the plurality of channels have a depth which is at least twice their width.

15. The slow sinking fishing weight of claim 11, wherein the plurality of channels comprise a first group of channels that extend along the fishing weight body and a second group of channels that extend along the fishing weight body and intersect the first group of channels and wherein the plurality of projections comprise posts located between the plurality of channels.

16. The slow sinking fishing weight of claim 11, wherein the body is made from a material that has a bulk density which is between about 2 percent and about 6 percent greater than the water.

17. The slow sinking fishing weight of claim 11, wherein the body is made from a material that has a bulk density which is about 4 percent greater than the water.

18. The slow sinking fishing weight of claim 11, wherein the slow sinking fishing weight has a sink rate in calm water which is between about 5 cm per second and about 20 cm per second.

19. The slow sinking fishing weight of claim 11, wherein the slow sinking fishing weight has a sink rate in calm water which is about 10 cm per second.

20. The slow sinking fishing weight of claim 11, further comprising a central plate that extends between the front end and the back end of the body and that extends from the central axis towards left and right sides of the body, and wherein the plurality of projections comprises top projections that extend from a top side of the central plate and bottom projections that extend from a bottom side of the central plate.
